(19) United States
(12) Patent Application Publication
(10) Pub. No.: US 2025/0271627 A1
(43) Pub. Date: Aug. 28, 2025

(54) DETACHABLE FIBER ARRAY UNIT FITTING WITH GUIDE PINS

(71) Applicant: Taiwan Semiconductor Manufacturing Co., Ltd., Hsinchu (TW)

(72) Inventors: Kai-Cheng Shie, Taichung City (TW); Tsung-Fu Tsai, Changhua City (TW); Szu-Wei Lu, Hsinchu (TW); Chen-Hua Yu, Hsinchu (TW)

(21) Appl. No.: 18/658,480

(22) Filed: May 8, 2024

Related U.S. Application Data
(60) Provisional application No. 63/558,970, filed on Feb. 28, 2024.

(51) Int. Cl. G02B 6/42

(52) U.S. Cl. CPC G02B 6/4231; G02B 6/4261; G02B 6/4293

(57) ABSTRACT

A structure comprises a ferrule receptacle, a device die extending into a cavity of the ferrule receptacle from a first edge of the ferrule receptacle, a guide pin at least partially in the cavity, and a detachable fiber array unit extending into the cavity from a second edge of the ferrule receptacle. The first edge and the second edge are opposite edges of the ferrule receptacle. The guide pin has a portion in a pin hole of the detachable fiber array unit.

### PRIORITY CLAIM AND CROSS-REFERENCE

This application claims the benefit of the following provisionally filed U.S. Patent application: Application No. 63/558,970, filed on Feb. 28, 2024, and entitled “DETACHABLE IFAU WITH GUIDE PIN,” which application is hereby incorporated herein by reference.

### BACKGROUND

As the bandwidth requirement grows rapidly for high-performance computing systems, high-speed optical Input/Output (I/O) modules have been used increasingly. The optical I/O modules are often connected to light sources (laser) as the circuit driving sources.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A, 1B, 1C, 1D, 1E, and 1F illustrate the views of a detachable fiber array unit and a photonic receiving unit including guide pins in accordance with some embodiments.

FIGS. 2A, 2B, 2C, and 2D illustrate the views of a detachable fiber array unit and a photonic receiving unit including guide pins in accordance with some embodiments.

FIGS. 3A, 3B, 3C, and 3D illustrate the views of a detachable fiber array unit and a photonic receiving unit including guide pins and alignment features in accordance with some embodiments.

FIGS. 4A, 4B, 5A, 5B, 6A, and 6B illustrate the views of detachable fiber array units and photonic receiving units in accordance with alternative embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “underlying,” “below,” “lower,” “overlying,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A package including a detachable fiber array unit, a photonic receiving unit, and alignment features are provided. In accordance with some embodiments of the present disclosure, the package includes a detachable fiber array unit including pin holes, and a photonic receiving unit that further includes a ferrule receptacle including guide pins. The guide pins and pin holes are used as the alignment features. The detachable fiber array unit is inserted into the ferrule receptacle, and the guide pins and the pin holes are used to align the detachable fiber array unit to the ferrule receptacle. Other alignment features including spring pushes may be used for further limiting and aligning the detachable fiber array unit to the ferrule receptacle. Additional alignment features having tilt surfaces are also used to limit and align the detachable fiber array unit to the ferrule receptacle.

Embodiments discussed herein are to provide examples to enable making or using the subject matter of this disclosure, and a person having ordinary skill in the art will readily understand modifications that can be made while remaining within contemplated scopes of different embodiments. Throughout the various views and illustrative embodiments, like reference numbers are used to designate like elements. Although method embodiments may be discussed as being performed in a particular order, other method embodiments may be performed in any logical order.

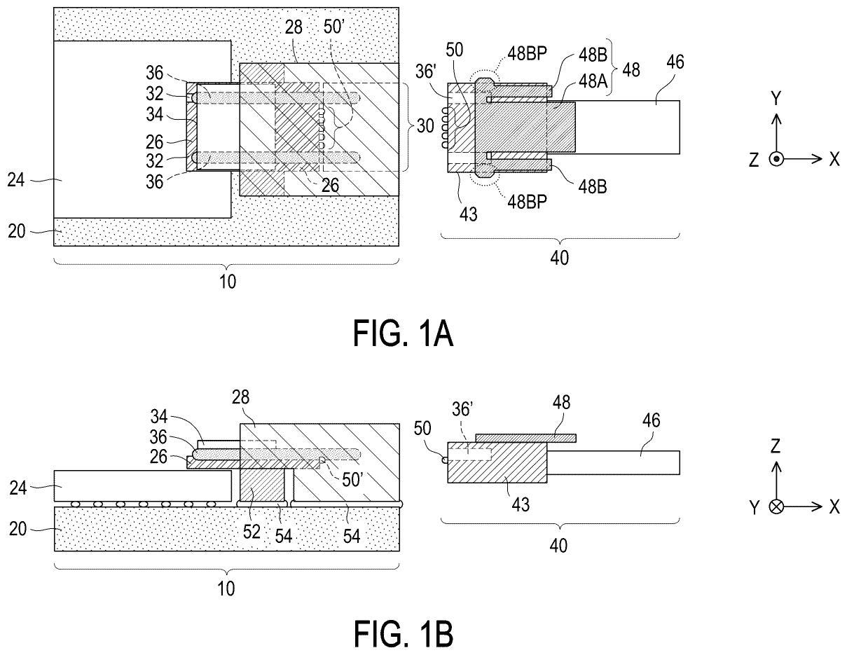

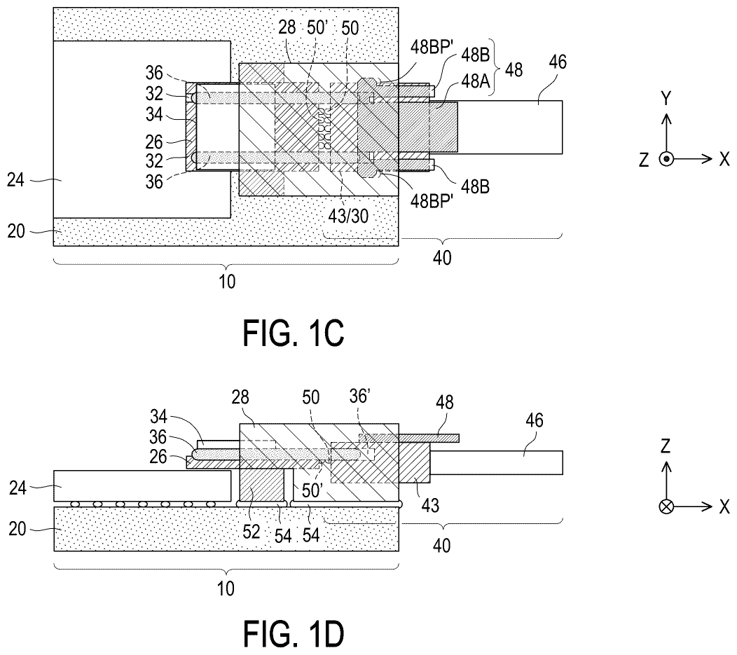

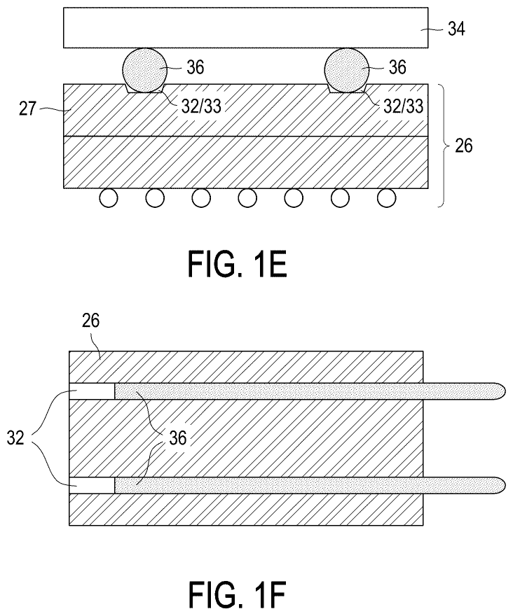

Referring to FIGS. 1A, 1B, 1C, 1D, 1E, and 1F, a part of a photonic receiving unit 10 is illustrated, which includes an optical engine therein. In accordance with some embodiments of the present disclosure, package component 20 is provided for attaching other components thereon. Package component 20 may include a package substrate, a printed circuit board, a package including other package components such as device dies, or the like. Electrical conductive features (not shown) may be formed on the opposite sides of package component 20, and are interconnected through the conductive paths (such as metal lines, vias, or the like, not shown) inside package component 20.

In accordance with some embodiments of the present disclosure, package component 24 is placed over and bonding to package component 20. The bonding may be performed through solder bonding, metal-to-metal direct bonding, dielectric-to-dielectric bonding, and/or the like. For example, solder bonding may be used for the bonding and electrically connecting package component 24 to package component 20.

In accordance with some embodiments of the present disclosure, package component 24 comprises an optical engine, and thus may alternatively be referred to as optical engine 24. In accordance with some embodiments of the present disclosure, package component 24 comprises a photonic Integrated circuit (PIC) die and an Electronic Integrated circuit (EIC) die bonding to the PIC die, which are not illustrated separately. The bonding between the EIC die and the PIC die may also include metal-to-metal direct bonding, solder bonding, or hybrid bonding.

In accordance with some embodiments of the present disclosure, the PIC die may include optical components including, and not limited to, silicon waveguides, (silicon) nitride waveguides, grating couplers, photodetectors, modulators, edge couplers, and/or the like. The PIC die may include a silicon substrate, on which the optical components are formed.

In accordance with some embodiments of the present disclosure, the EIC die may include integrated circuits for interfacing with the PIC, such as the circuits for controlling the operation of the PIC. For example, the EIC may include controllers, drivers, amplifiers, the like, or combinations thereof. the EIC may also include a CPU. In accordance with some embodiments of the present disclosure, the EIC includes the circuits for processing electrical signals received from the PIC. The EIC may also control high-frequency signaling of the PIC according to electrical signals (digital or analog) received from another device or die, in accordance with some embodiments. In accordance with some embodiments of the present disclosure, the EIC may include a circuit that provides Serializer/Deserializer (SerDes) functionality. In this manner, the EIC may act as a part of an I/O interface between optical signals and electrical signals.

Package component 26 is over and bonded to package component 24. In accordance with some embodiments of the present disclosure, device die 26 is a die including a wave guide to optically couple to a Fiber Array Unit (FAU). In accordance with some embodiments of the present disclosure, package component 26 is a device die, and may be a PIC die, and may be a part of the optical engine. Package component 26 may have the function of receiving optical signals or transmitting optical signals from/to a detachable fiber array unit, and receiving/transmitting the optical signals to package component 24. In accordance with alternative embodiments, package component 26, in addition to receiving or transmitting optical signal, may convert the optical signals to electrical signals or electrical signals to optical signal.

Ferrule receptacle 28 is attached to package components 26 and 24. Ferrule receptacle 28 has a cavity 30 therein, so that ferrule 42 and ferrule housing 44 may be inserted into the cavity 30 of ferrule receptacle 28.

In accordance with some embodiments of the present disclosure, grooves 32 are formed in package component 26. Referring to FIG. 1E, when package component 26 is a device die, the top surface portion of the package component 26 may be semiconductor substrate 27. The semiconductor substrate 27 may further be a silicon substrate in accordance with some embodiments. Grooves 32 may extend from the top surface of the semiconductor substrate 27 into the semiconductor substrate 27. Grooves 32 may be formed by etching, milling, sawing, or the like. The lengthwise direction of grooves 32 is parallel to the insertion (and pulling out) direction of detachable fiber array unit 40, as will be discussed in detail in subsequent paragraphs.

As shown in FIGS. 1A and-1F, guide pins 36 are placed in, and thus are fixed by, grooves 32. In accordance with some embodiments, the lower parts of guide pins 36 are in grooves 32, while the upper parts of guide pins 36 are out of grooves 32. Top lid 34 is placed on and pressed on guide pins 36, so that guide pins 36 are secured by top lid 34. In accordance with some embodiments as shown in FIG. 1E, adhesive 33 may be dispensed in grooves 32 to further secure guide pins 36 in positions.

In accordance with some embodiments of the present disclosure, guide pins 36 are formed of a metal or a metal alloy such as copper, aluminum, stainless steel, or the like. Since metal has high machining accuracy, the alignment accuracy using guide pins 36 is high, and guide pins 36 may tightly fit the corresponding pin holes.

FIG. 1F illustrates a top view of the grooves 32 in package component 26 in accordance with some embodiments. The lengthwise direction of grooves 32 is parallel to edges of the package component 26. When viewed from the top of package component 26, the grooves 32 extend to the right edge of package component 26, and may extend to the left edge. Alternatively, the left ends of grooves 32 may be spaced apart from the left edge of package component 26. Guide pins 36 include some portions in grooves 32, and further comprise some portions extending beyond the right edge of package component 26. In accordance with some embodiments of the present disclosure, guide pins 36 have tapered right ends such as rounded right end portions, with the parts of guide pins 36 in grooves 32 having a uniform width and a uniform diameter.

Referring again to FIGS. 1A-1D, detachable fiber array unit 40 is formed in accordance with some embodiments. Detachable fiber array unit 40 is configured to be inserted into, and pulled out of, ferrule receptacle 28. Detachable fiber array unit 40 includes ferrule 42, ferrule housing 44, optical fibers 46, spring push 48, and features 50. Detachable fiber array unit 40 is configured to be inserted into the cavity 30 of the ferrule receptacle 28. In accordance with some embodiments of the present disclosure, ferrule housing 44 has the function of holding and securing a part of the ferrule 42 and a part of the optical fibers 46 as an integrated component.

The ferrule 42 and ferrule housing 44 may be separate components manufactured separately and then assembled together as the integral component. In accordance with alternative embodiments, the ferrule 42 and ferrule housing 44 may be formed as an integrated unit and formed of a same material, for example, in a same molding process. Throughout the description, ferrule 42 and ferrule housing 44 are collectively referred to as ferrule unit 43, and may not be shown separately in subsequent figures.

Features 50 are optically coupled to optical fibers 46. Features 50 are capable of transferring light, and may be lens array or fiber protrusions, which may (or may not) have the ability of focusing light. Features 50 may have different pitches than optical fibers 46, and hence are used as a converting unit for converting pitches. Features 50 may have flat or curved end faces, which may or may not have the capability of focusing light. The pitch of features 50 can be the same as or different from the pitch of optical fibers 46. There may be a plurality of features 50 arranged as an array.

In accordance with some embodiments, each of the plurality of features 50 may be connected to, and configured to receive optical signals from, a respective one of the plurality of optical fibers 46. In accordance with alternative embodiments, each of the plurality of features 50 is configured to send optical signals to a respective one of the plurality of optical fibers 46. In subsequently discussed examples, it is assumed that optical signals are received into package component 26 from optical fibers 46 through features 50, while the optical signals may also be transmitted in an inversed direction also.

Detachable fiber array unit 40 may include spring push 48 attached to the ferrule unit 43. The attachment may be through screwing, soldering, clipping, or the like. Spring push 48 is flexible, and may be used for securing the detachable fiber array unit 40 in cavity 30. In accordance with some embodiments of the present disclosure, spring push 48 is formed of a metallic material such as copper, stainless steel, or the like. By forming spring push 48 using metal, the machining accuracy is improved, and spring push 48 have high accuracy for aligning the detachable fiber array unit 40 to cavity 30. As a comparison, if spring push 48 is formed using other materials such as plastics, the machining accuracy will be low, and the alignment accuracy is degraded.

FIGS. 1A and 1B illustrate a top view and a cross-sectional view, respectively, of photonic receiving unit 10 and detachable fiber array unit 40 in accordance with some embodiments. In FIGS. 1A and 1B and subsequent figures, X-direction, Y-direction, and Z-direction are marked. The X-direction is the direction in which detachable fiber array unit 40 is inserted into and pulled out of cavity 30. The Y-direction is the direction perpendicular to the X-direction, and is parallel to the major top surfaces of package components 26 and 28. The Z-direction is the direction perpendicular to the major top surfaces of package components 26 and 28. In addition, the subsequently illustrated figures illustrate some features as being semi-transparent in order to show the features inside these features, while these features may actually be formed of opaque materials or transparent materials in reality.

FIG. 1A illustrates that guide pins 36 protrude out of the right edge of package component 26. In addition, package component 26 may include features 50′, which are parts of an edge coupler (not shown) of package component 26. The right ends of features 50′ may protrude out of, or may be flush with, the right edge of the main portion of package component 26. The number and the positions of features 50′ are designed according to the arrangement of features 50 (in detachable fiber array unit 40) with a one-to-one correspondence.

FIG. 1A also illustrates that package component 26 extends from left side into a left part of ferrule receptacle 28. Guide pins 36 extend into and are exposed to the cavity 30 of the ferrule receptacle 28. Also, the end portions of features 50′ are exposed to, and may possibly extend into, the cavity 30 of the ferrule receptacle 28.

FIG. 1A also illustrates detachable fiber array unit 40, which includes ferrule unit 43 and optical fibers 46 attached to the ferrule unit 43. In ferrule unit 43, pin holes 36′ are formed. The formation process may include drilling, molding, or the like. The size of pin holes 36′ is designed to tightly fit guide pins 36, so that when guide pins 36 are inserted into pin holes 36′, guide pins 36 are not movable in pin holes 36′ in the Y-direction and Z-direction.

In accordance with some embodiments of the present disclosure, spring push 48 is attached to ferrule unit 43. Spring push 48 includes body 48A, and buckles 48B attached to the opposite sides of body 48A. The body 48A may be used to attach to ferrule unit 43. The buckles 48B are flexible, and may move slightly toward body 48A when being squeezed in the Y-direction.

In accordance with some embodiments of the present disclosure, the buckles 48B comprise protruding portions 48BP. The protruding portions 48BP have slanted surfaces facing toward ferrule receptacle 28, which slanted surfaces help to squeeze protruding portions 48BP when protruding portions 48BP are forced into cavity 30. The protruding portions 48BP further have slanted surface facing away from ferrule receptacle 28, which slanted surfaces help to squeeze protruding portions 48BP when protruding portions 48BP are pulled out of cavity 30.

FIG. 1B illustrates a cross-sectional view, which shows that support element 52 is attached to the package component 20 through adhesive 54. Support element 52 supports the right portion of package component 26. Ferrule receptacle 28 may also be attached to the package component 20 through adhesive 54. As shown in the cross-sectional view, spring push 48 is secured on ferrule housing 43, for example, through an adhesive, a screw, or the like.

FIGS. 1C and 1D illustrate a top view and a cross-sectional view of photonic receiving unit 10 and detachable fiber array unit 40, respectively, after detachable fiber array unit 40 has been inserted into ferrule receptacle 28. The front end of detachable fiber array unit 40 is inserted into cavity 30 (refer to FIG. 1C). In accordance with some embodiments of the present disclosure, features 50 of the detachable fiber array unit 40 are aligned to the respective features 50′ of the photonic receiving unit 10, so that features 50 may be optically and signally coupled to the features 50′.

In accordance with some embodiments of the present disclosure, guide pins 36 are inserted into pin holes 36′. Since the guide pins 36 tightly fit pin holes 36′, the relative position of the detachable fiber array unit 40 and photonic receiving unit 10 are fixed, which leads to the accurate alignment of features 50 to features 50′.

Referring to FIG. 1C, during the insertion process, the buckles 48B of the spring push 48 are squeezed by the inner sidewalls of ferrule receptacle 28, and the detachable fiber array unit 40 is forced into cavity 30. Furthermore, the ferrule receptacle 28 may have recesses 48BP′ (FIG. 1C) that are recessed from the inner sidewalls of ferrule receptacle 28 into the sidewall portions of the ferrule receptacle 28. When the detachable fiber array unit 40 is inserted into the desirable position, the protruding portions 48BP of buckles 48B, which protruding portions protrude in the Y-direction (FIG. 1A) will be seated inside the recesses 48BP′ of the ferrule receptacle 28.

In accordance with some embodiments of the present disclosure, after the detachable fiber array unit 40 has been inserted into ferrule receptacle 28 and fixed in position, features 50 may be in physical contact with the respective features 50′. In accordance with alternative embodiments, after the detachable fiber array unit 40 has been inserted into ferrule receptacle 28 and fixed in position, features 50 are physically spaced apart from, closely located to, and are optically coupled to, the respective features 50′, so that optical signals may be transmitted between features 50 and features 50′.

In accordance with some embodiments of the present disclosure, optical signals may be received from optical fibers 46, transmitted through features 50, and optically coupled to features 50′ in package component 26. The optical signals may be processed and possibly converted to electrical signals in the package component 26, or transmitted optically to package component 24, and are converted to electrical signals in package component 24. Signals may also be transmitted in an inversed direction. For example, electrical signals may be converted as optical signals in package component 24 and transmitted to package component 26. The electrical signals may also be transmitted to package component 26 and converted to optical signals in package component 26. The optical signals are optically coupled from features 50′ to features 50, and then transmitted to optical fibers 46.

As shown in FIGS. 1C and 1D, the alignment of detachable fiber array unit 40 to photonic receiving unit 10 is achieved by two mechanisms. Guide pins 36 and pin holes 36′ are used to limit the relative movement of detachable fiber array unit 40 from ferrule receptacle 28 in all of the X-direction, Y-direction and the Z-direction. Spring push 48 may be used to limit the relative movement of detachable fiber array unit 40 from ferrule receptacle 28 in the Y-direction. The buckles 48BP, when being located in the recesses 48BP′ (FIG. 1C) of ferrule receptacle 28, may also have the function of limiting the relative movement of detachable fiber array unit 40 from ferrule receptacle 28 in the X-direction, Y-direction, and Z-direction.

As may be realized, detachable fiber array unit 40 may also be pulled out of ferrule receptacle 28, for example, by squeezing buckles 48B of the spring push 48, so that the protruding portions 48BP may be slightly pushed out of the recesses 48BP′ in which protruding portions 48BP are seated. In addition, the protruding portions 48BP have slanted sidewalls facing the X-direction, so that the pulling force also helps to squeeze buckles 48B, allowing buckles 48B to be forced out of cavity 30.

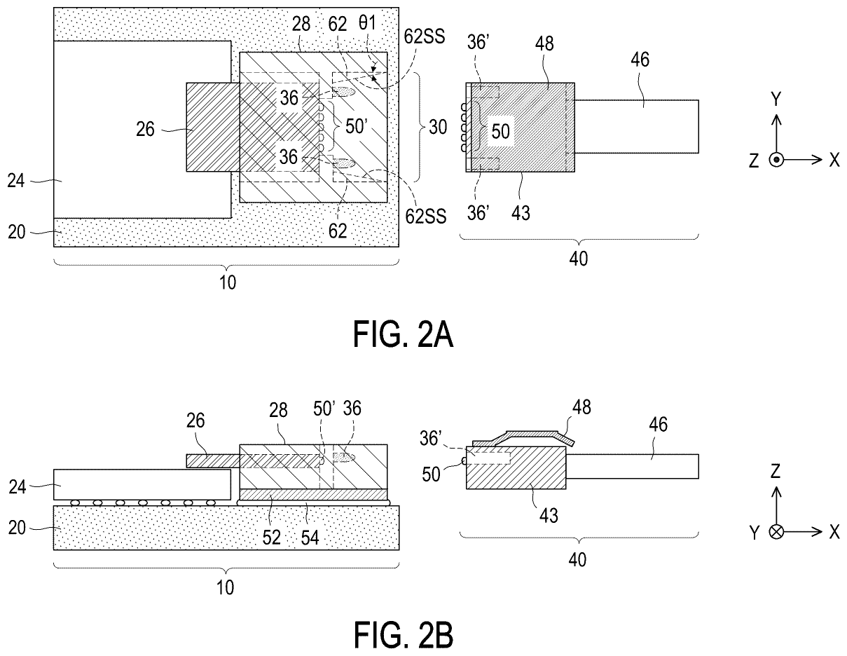

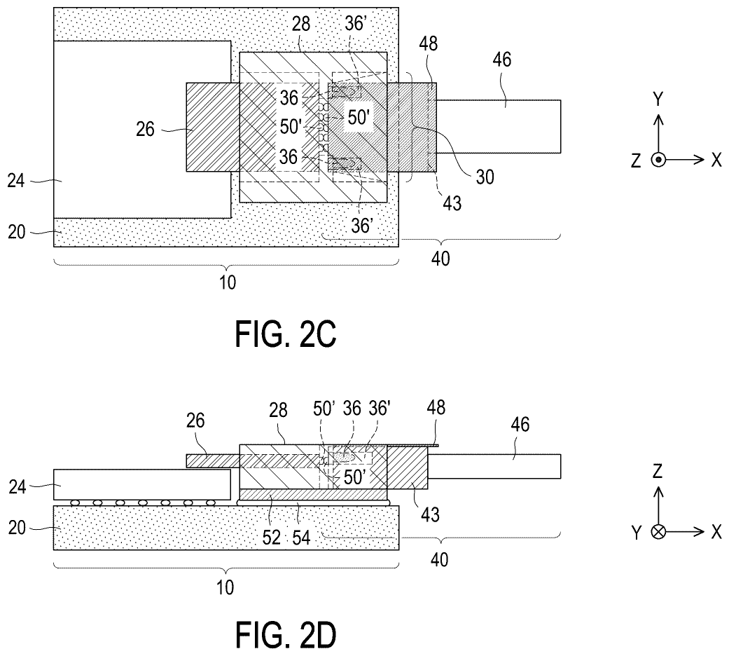

FIGS. 2A, 2B, 2C, and 2D illustrate the photonic receiving unit 10 and the detachable fiber array unit 40 in accordance with alternative embodiments. Unless specified otherwise, the materials, the structures, and the formation processes of the components in these embodiments are essentially the same as the like components denoted by like reference numerals in the preceding embodiments. The details regarding the materials, the structures, and the formation processes provided in each of the embodiments throughout the description may be applied to any other embodiment whenever applicable.

FIGS. 2A and 2B illustrate a top view and a cross-sectional view of detachable fiber array unit 40 and photonic receiving unit 10 in accordance with some embodiments of the present disclosure. The views are obtained before the detachable fiber array unit 40 is inserted into the ferrule receptacle 28. The top view is obtained from a plane cross-section parallel to the plane defined by the X-direction and the Y-direction, and the plane cross-section cuts through cavity 30.

In accordance with some embodiments of the present disclosure, guide pins 36 are attached to ferrule receptacle 28, rather than being fixed in the grooves of the package component 26. In accordance with some embodiments of the present disclosure, guide pins 36 are formed of a metal or a metal alloy such as copper, aluminum, stainless steel or the like. Since metal has high machining accuracy, the alignment accuracy using metal guide pins 36 is high.

In accordance with alternative embodiments, guide pins 36 are formed of a same material as the body of ferrule receptacle 28, so that guide pins 36 and the body of ferrule receptacle 28 may be formed in a same manufacturing process, and the cost of attaching the separately manufactured guide pins 36 and the body of ferrule receptacle 28 is saved. In accordance with these embodiments, guide pins 36 and the body of ferrule receptacle 28 may be formed of a metal such as copper, aluminum, stainless steel, or the like, or another material such as a plastic, a polymer, a resin, an epoxy, a ceramic, or the like.

Pin holes 36′ are also formed in the detachable fiber array unit 40, for example, through drilling, molding, or the like. Alternatively, pin holes 36′ are formed as an integrated part of ferrule housing 43 in the molding process for forming ferrule housing 43.

In addition, alignment features 62 are formed inside cavity 30 of the ferrule receptacle 28. In accordance with some embodiments of the present disclosure, the alignment features 62 have tilted surfaces 62SS, which are not parallel to the X-direction. A tilt angle θ1 formed between the tilted surface 62SS and the X-direction may be in the range between (and greater than) 0 degrees and about 10 degrees. In accordance with some embodiments, alignment features 62 are formed of a material different from the material of the body of ferrule receptacle 28. Alignment features 62 may be pre-formed, and then placed inside cavity 30. In accordance with alternative embodiments, alignment features 62 are formed of a same material as the body of ferrule receptacle 28, so that alignment features 62 and the body of ferrule receptacle 28 may be formed in a same manufacturing process, and are formed as an integral component, for example, in the same molding process.

Referring to FIGS. 2C and 2D, which illustrate a top view and a cross-sectional view, respectively, the detachable fiber array unit 40 as shown in FIGS. 2A and 2B is inserted into ferrule receptacle 28. Features 50 are either in physical contact with features 50′, or may be spaced apart but are located close to features 50′, so that features 50 are optically coupled to features 50′. The spring push 48 (FIG. 2B) is forced to be flat when the detachable fiber array unit 40 is inserted into ferrule receptacle 28, and may provide a force (in the Z-direction) for tightening the attachment of detachable fiber array unit 40 to the ferrule receptacle 28.

In the insertion process, guide pins 36 are aligned to and inserted into pin holes 36′, so that features 50 may be aligned to features 50′ accurately. In addition, the alignment features 62 may help the alignment. The tilted surfaces 62SS allow the entrance of cavity 30 to be slightly larger than the size of the detachable fiber array unit 40, so that the insertion is easy. With the detachable fiber array unit 40 being pushed into cavity 30, the tilted surfaces 62SS guide the detachable fiber array unit 40 to the center (in the top view in FIG. 2C) of cavity 30, and also guide the pin holes 36′ to be aligned to guide pins 36.

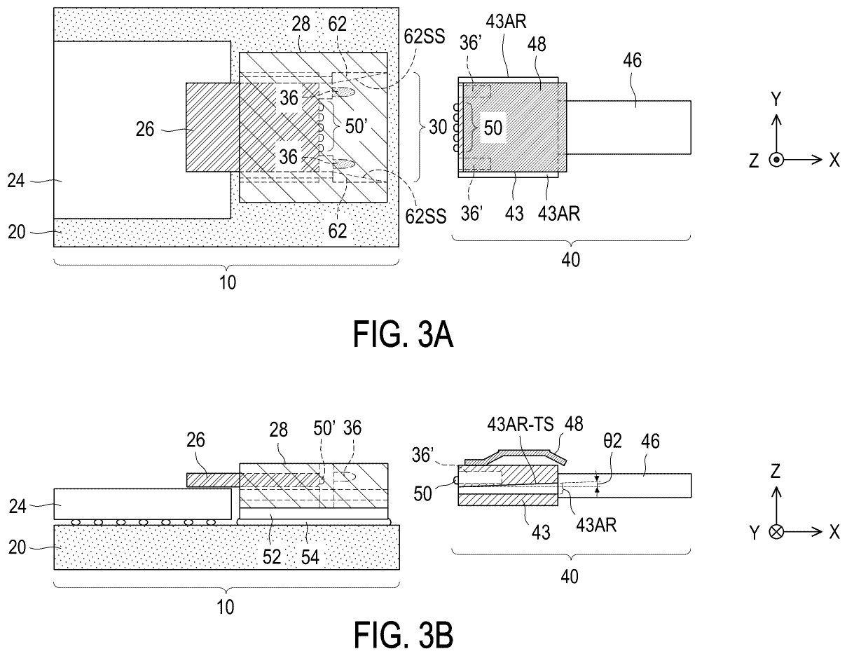

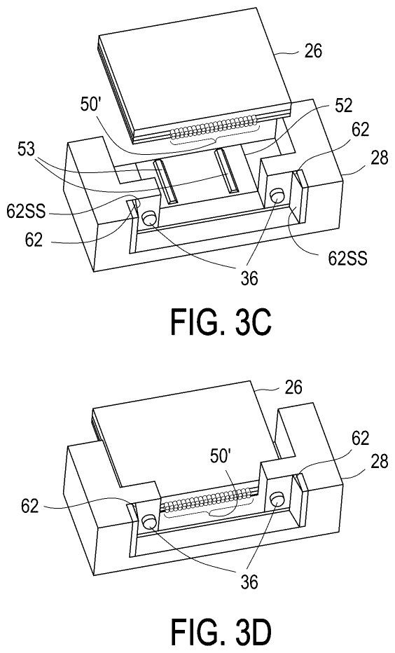

FIGS. 3A, 3B, 3C, and 3D illustrate the views in accordance with some embodiments. FIGS. 3A and 3B illustrate a top view and a cross-sectional view of detachable fiber array unit 40 and photonic receiving unit 10 in accordance with some embodiments of the present disclosure. The views are obtained before the detachable fiber array unit 40 is inserted into the ferrule receptacle 28. The fiber array unit 40 and photonic receiving unit 10 in accordance with these embodiments are essentially the same as in the embodiments in FIGS. 2A and 2B, except that alignment rail 43AR (in detachable fiber array unit 40) and the corresponding rail recesses are further formed as alignment features. The rail recesses are not illustrated, and are formed in ferrule receptacle 28, with the shapes and sizes of the rail recesses being configured to allow the alignment rail 43AR to tightly fit therein and to slide therein.

Referring to FIG. 3A, alignment rails 43AR are formed as the side protruding portions of the ferrule housing 43, and protrude out of (in the Y-directions) the main body of the ferrule housing 43. As shown in FIG. 3B, alignment rails 43AR may have slanted top surfaces 43AR-TS, which are slightly offset from the X-Y plane, which is defined by the X-direction and the Y-direction. A tilt angle 02 formed between the slant to surface 43AR-TS and the X-Y plane may be in the range between (and greater than) o degrees and about 10 degrees.

FIG. 3B further illustrates spring push 48 in accordance with alternative embodiments. The spring push 48 is flexible in the Z-direction, and has portions raised higher (with a gap underneath) than the top surface of ferrule housing 43.

It is appreciated that although alignment rails 43AR are parts of the detachable fiber array unit 40, and rail recesses 43AR′ are in the ferrule receptacle 28 in accordance with some embodiments, the locations may be switched. In accordance with alternative embodiments, the alignment rails 43AR are parts of the ferrule receptacle 28 and in the cavity 30, and rail recesses 43AR′ are in the detachable fiber array unit 40.

In accordance with some embodiments of the present disclosure, when the detachable fiber array unit 40 is inserted into the ferrule receptacle 28, alignment rails 43AR slide in rail recesses 43AR′. Since the front ends of alignment rails 43AR are smaller than the back ends, it is easy to insert alignment rails 43AR into rail recesses 43AR′. The back ends of alignment rails 43AR have the same height as the height of the back ends of alignment recesses 43AR′, so that when the detachable fiber array unit 40 reaches the desirable position, the back ends of alignment rails 43AR tightly fit the entrance portions of rail recesses 43AR′.

FIGS. 3C and 3D illustrate the package component 26 and a part of the ferrule receptacle 28 in accordance with some embodiments. FIG. 3C illustrates the structure before package component 26 is attached to the ferrule receptacle 28. FIG. 3D illustrates the structure after package component 26 is attached to the ferrule receptacle 28. It is appreciated that FIGS. 3C and 3D may also represent the perspective views of the embodiments shown in FIGS. 2A, 2B, 2C, and 2D. The rail recesses are not shown. Alignment features 53 are formed on support element 52 for aligning package component 26 to ferrule receptacle 28.

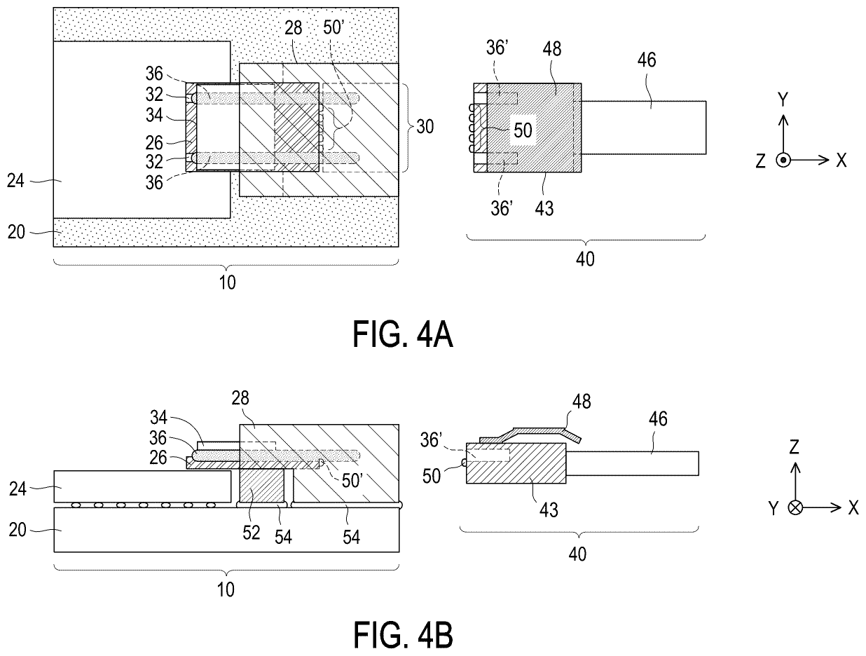

It is appreciated that the plurality of alignment features of the present disclosure may be combined in any combination whenever applicable. For example, FIGS. 4A and 4B illustrate the photonic receiving unit 10 and the detachable fiber array unit 40 in accordance with alternative embodiments. In these embodiments, the guide pins 36 are adopted from the embodiments shown in FIGS. 1A through 1F. Accordingly, the guide pins 36 are placed in the grooves 32 in the package component 26, and is pressed and secured by top lid 34. The spring push 48, on the other hand, is adopted from the embodiments shown in FIGS. 2A through 2D. Accordingly, after the detachable fiber array unit 40 is inserted into the ferrule receptacle 28, the spring push 48 will be forced to be flat, and will provide a force for fixing the relative position of the detachable fiber array unit 40 in the Z-direction.

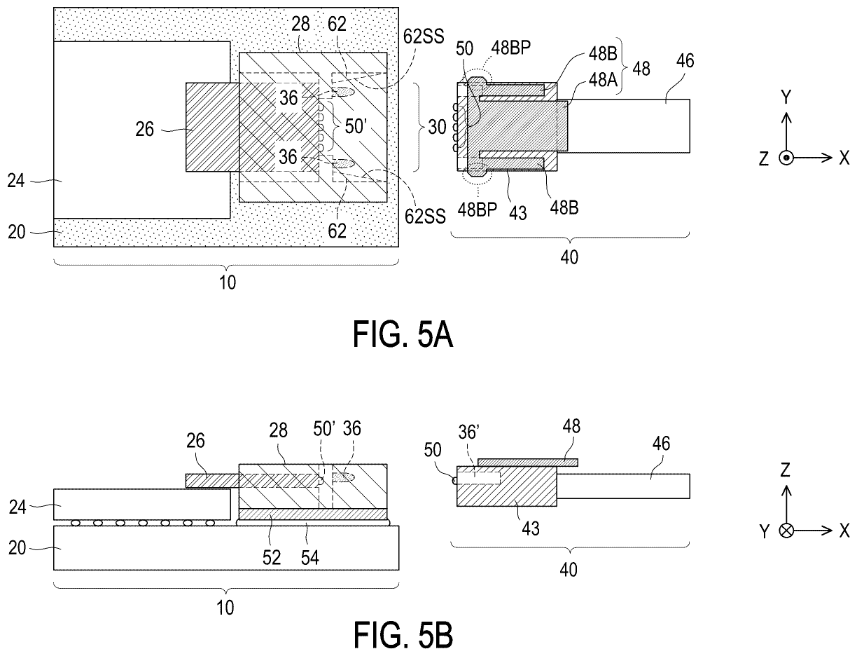

FIGS. 5A and 5B illustrate the photonic receiving unit 10 and the detachable fiber array unit 40 in accordance with alternative embodiments. In these embodiments, the guide pins 36 are adopted from the embodiments shown in FIGS. 2A through 2D (and FIGS. 3A and 3B). Accordingly, the guide pins 36 are attached to ferrule receptacle 28. The spring push 48, on the other hand, is adopted from the embodiments shown in FIGS. 1A through 1F. Accordingly, during the insertion of the detachable fiber array unit 40 into the ferrule receptacle 28, the spring push 48 is squeezed in the Y-direction, and provides a force for fixing the relative position of the detachable fiber array unit 40 in the Y-direction. The spring push 48, with protruding portions protruding in the Y-directions, also has the function of holding the detachable fiber array unit 40 in ferrule receptacle 28.

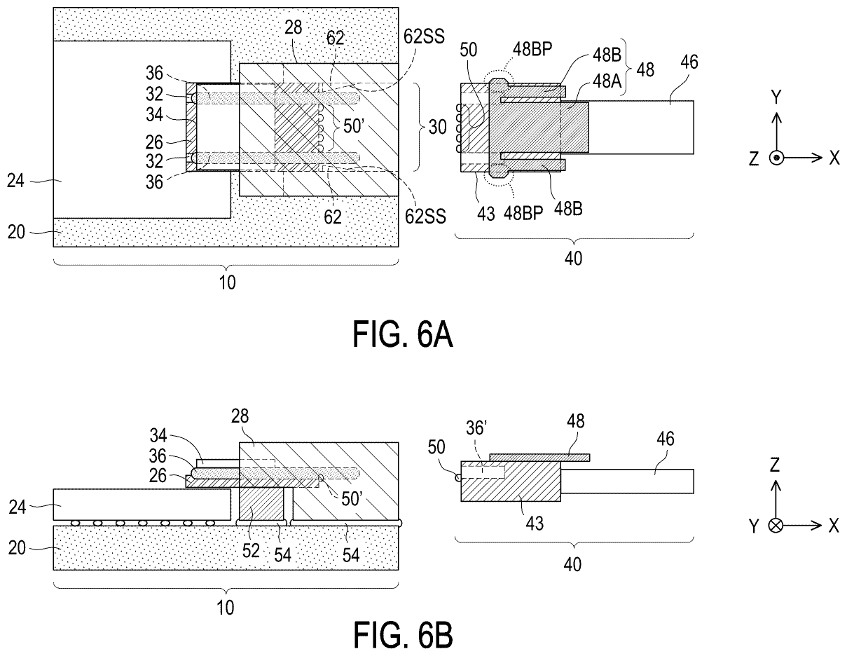

FIGS. 6A and 6B illustrate the photonic receiving unit 10 and the detachable fiber array unit 40 in accordance with yet alternative embodiments. In these embodiments, both of the guide pins 36 and the spring push 48 are adopted from the embodiments shown in FIGS. 1A through 1F. Accordingly, the guide pins 36 are placed in the grooves 32 in the package component 26, and are pushed and secured by top lid 34. During the insertion of the detachable fiber array unit 40 into the ferrule receptacle 28, the spring push 48 is squeezed in the Y-direction, and provides a force for fixing the relative position of the detachable fiber array unit 40 in the Y-direction. The spring push 48, with protruding portions 48BP protruding in the Y-directions, also have the function of holding the detachable fiber array unit 40 in ferrule receptacle 28.

The embodiment as shown in FIGS. 6A and 6B also include the alignment features 62 as shown in FIGS. 2A through 2D (and FIGS. 3A and 3B), which are used for guiding the insertion of the detachable fiber array unit 40 into the ferrule receptacle 28.

The embodiments of the present disclosure have some advantageous features. By forming alignment features such as guide pins, spring pushes, alignment features with tilted surfaces, alignment rails, etc., the alignment of the detachable fiber array units to ferrule receptacles is improved. Furthermore, metal may be used for forming alignment features. Due to the high machining accuracy of metal over other materials, the accuracy of the alignment is improved.

In accordance with some embodiments of the present disclosure, a structure comprises a photonic receiving unit comprising a ferrule receptacle; a die comprising a first waveguide, wherein a part of the first waveguide is in a cavity of the ferrule receptacle; and a guide pin at least partially in the cavity of the ferrule receptacle; and a detachable fiber array unit comprising a ferrule housing; an optical fiber with a part in the ferrule housing; and a second waveguide optically coupled to the optical fiber, wherein an end of the second waveguide is on a side of the ferrule housing; and a pin hole in the ferrule housing, wherein the detachable fiber array unit is configured to be capable of being inserted into the cavity of the ferrule receptacle, and wherein when the detachable fiber array unit is inserted in the cavity, the guide pin comprises a portion in the pin hole, and the second waveguide is optically coupled to the first waveguide.

In an embodiment, the guide pin comprises a first portion in a groove of the die, and a second portion protruding beyond an edge of the die, with the second portion being in the cavity. In an embodiment, the photonic receiving unit further comprises an additional guide pin, and the detachable fiber array unit further comprises an additional pin hole, and wherein when the detachable fiber array unit is inserted in the cavity, the additional guide pin comprises a portion in the additional pin hole. In an embodiment, the guide pin is attached to the ferrule receptacle to form an integral component.

In an embodiment, the detachable fiber array unit further comprises a spring push. In an embodiment, the spring push comprises a metal. In an embodiment, the ferrule receptacle further comprises two alignment features in the cavity, wherein the two alignment features comprise tilted surfaces facing the cavity and opposite to each other, and the detachable fiber array unit is configured to be limited by the tilted surfaces when inserted into the ferrule receptacle. In an embodiment, the guide pin comprises a metal.

In an embodiment, the ferrule receptacle further comprises a rail recess, and the ferrule housing further comprises a rail on an edge of the ferrule housing, wherein the rail is configured to slide in the rail recess when the detachable fiber array unit is inserted into the ferrule receptacle. In an embodiment, the photonic receiving unit comprises a photonic die and an electronic die, with the die being one of the photonic die and the electronic die. In an embodiment, the structure further comprises a package substrate, wherein the die is over and electrically coupling to the package substrate.

In accordance with some embodiments of the present disclosure, a structure comprises a first device die comprising a substrate; a guide pin, wherein a portion of the guide pin comprises a part in a groove of the substrate; a ferrule receptacle, wherein the first device die and the guide pin comprise portions in a cavity of the ferrule receptacle; and a detachable fiber array unit comprising a ferrule housing comprising a pin hole, wherein the detachable fiber array unit is configured to be inserted into the ferrule receptacle, and the guide pin is configured to be inserted into the pin hole. In an embodiment, the guide pin comprises a metal, and the substrate comprises a semiconductor substrate.

In an embodiment, the structure further comprises a second device die overlapped by a first part of the first device die and signally coupled to the first device die; and a package component underlying and electrically coupling to the second device die. In an embodiment, the structure further comprises a support element between the package component and a second part of the first device die. In an embodiment, the structure further comprises an adhesive in the groove and adhering the guide pin to the first device die.

In accordance with some embodiments of the present disclosure, a structure comprises a ferrule receptacle; a device die extending into a cavity of the ferrule receptacle from a first edge of the ferrule receptacle; a guide pin at least partially in the cavity; and a detachable fiber array unit extending into the cavity from a second edge of the ferrule receptacle, wherein the first edge and the second edge are opposite edges of the ferrule receptacle, and wherein the guide pin comprises a portion in a pin hole of the detachable fiber array unit. In an embodiment, the guide pin is a discrete guide pin that is physically detachable from the ferrule receptacle. In an embodiment, the guide pin is an integral part of the ferrule receptacle. In an embodiment, the detachable fiber array unit further comprises a spring push comprising a part in the cavity.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A structure comprising:
a photonic receiving unit comprising:
a ferrule receptacle;
a die comprising a first waveguide, wherein a part of the first waveguide is in a cavity of the ferrule receptacle; and
a guide pin at least partially in the cavity of the ferrule receptacle; and
a detachable fiber array unit comprising:
a ferrule housing;
an optical fiber with a part in the ferrule housing; and
a second waveguide optically coupled to the optical fiber, wherein an end of the second waveguide is on a side of the ferrule housing; and
a pin hole in the ferrule housing, wherein the detachable fiber array unit is configured to be capable of being inserted into the cavity of the ferrule receptacle, and wherein when the detachable fiber array unit is inserted in the cavity, the guide pin comprises a portion in the pin hole, and the second waveguide is optically coupled to the first waveguide.

2. The structure of claim 1, wherein the guide pin comprises a first portion in a groove of the die, and a second portion protruding beyond an edge of the die, with the second portion being in the cavity.

3. The structure of claim 1, wherein the photonic receiving unit further comprises an additional guide pin, and the detachable fiber array unit further comprises an additional pin hole, and wherein when the detachable fiber array unit is inserted in the cavity, the additional guide pin comprises a portion in the additional pin hole.

4. The structure of claim 1, wherein the guide pin is attached to the ferrule receptacle to form an integral component.

5. The structure of claim 1, wherein the detachable fiber array unit further comprises a spring push.

6. The structure of claim 5, wherein the spring push comprises a metal.

7. The structure of claim 1, wherein the ferrule receptacle further comprises two alignment features in the cavity, wherein the two alignment features comprise tilted surfaces facing the cavity and opposite to each other, and the detachable fiber array unit is configured to be limited by the tilted surfaces when inserted into the ferrule receptacle.

8. The structure of claim 1, wherein the guide pin comprises a metal.

9. The structure of claim 1, wherein the ferrule receptacle further comprises a rail recess, and the ferrule housing further comprises a rail on an edge of the ferrule housing, wherein the rail is configured to slide in the rail recess when the detachable fiber array unit is inserted into the ferrule receptacle.

10. The structure of claim 1, wherein the photonic receiving unit comprises a photonic die and an electronic die, with the die being one of the photonic die and the electronic die.

11. The structure of claim 1 further comprising a package substrate, wherein the die is over and electrically coupling to the package substrate.

12. A structure comprising:
a first device die comprising a substrate;
a guide pin, wherein a portion of the guide pin comprises a part in a groove of the substrate;
a ferrule receptacle, wherein the first device die and the guide pin comprise portions in a cavity of the ferrule receptacle; and
a detachable fiber array unit comprising:
a ferrule housing comprising a pin hole, wherein the detachable fiber array unit is configured to be inserted into the ferrule receptacle, and the guide pin is configured to be inserted into the pin hole.

13. The structure of claim 12, wherein the guide pin comprises a metal, and the substrate comprises a semiconductor substrate.

14. The structure of claim 12 further comprising:
a second device die overlapped by a first part of the first device die and signally coupled to the first device die; and
a package component underlying and electrically coupling to the second device die.

15. The structure of claim 14 further comprising:
a support element between the package component and a second part of the first device die.

16. The structure of claim 12 further comprising an adhesive in the groove and adhering the guide pin to the first device die.

17. A structure comprising:
a ferrule receptacle;
a device die extending into a cavity of the ferrule receptacle from a first edge of the ferrule receptacle;
a guide pin at least partially in the cavity; and
a detachable fiber array unit extending into the cavity from a second edge of the ferrule receptacle, wherein the first edge and the second edge are opposite edges of the ferrule receptacle, and wherein the guide pin comprises a portion in a pin hole of the detachable fiber array unit.

18. The structure of claim 17, wherein the guide pin is a discrete guide pin that is physically detachable from the ferrule receptacle.

19. The structure of claim 17, wherein the guide pin is an integral part of the ferrule receptacle.

20. The structure of claim 17, wherein the detachable fiber array unit further comprises a spring push comprising a part in the cavity.
